(19) United States
(12) Patent Application Publication
(10) Pub. No.: US 2020/0101418 A1
(43) Pub. Date: Apr. 2, 2020

(54) FLUORINE-CONTAINING GAS DECOMPOSING/REMOVING AGENT, METHOD FOR PRODUCING SAME, AND FLUORINE-CONTAINING GAS REMOVING METHOD AND FLUORINE RESOURCE RECOVERY METHOD EACH USING SAME

(71) Applicant: CLARIANT CATALYSTS (JAPAN) K.K., Tokyo (JP)

(72) Inventors: Tadahito NAKASHIMA, Toyama (JP); Hyun-Joong KIM, Toyama (JP)

(21) Appl. No.: 16/618,908

(22) PCT Filed: Apr. 10, 2018
(86) PCT No.: PCT/JP2018/014979

§ 371 Date: Dec. 3, 2019

(30) Foreign Application Priority Data
Jun. 16, 2017 (JP) 2017-118270

(51) Int. Cl. B01D 53/70; B01D 53/14; B01J 21/04; B01D 53/81; B01D 53/86; B01J 20/04; B01J 20/08; B01J 20/28; B01J 20/30; B01J 37/04

(52) U.S. Cl. CPC B01D 53/70; B01D 53/14; B01J 21/04; B01D 53/81; B01D 53/8662; B01J 20/041; B01D 2255/2092; B01J 20/08; B01J 20/28; B01J 20/3014; B01J 37/04; B01D 2257/2066; B01J 20/043

(57) ABSTRACT

The present invention relates to a fluorine-containing gas removing agent comprising an alumina and an alkali earth metal compound, wherein an ammonia desorption curve obtained by an ammonia TPD-MS method having a mass-to-charge ratio of 15 has a peak in a range lower than 200° C. and has a shoulder in a range of 200° C. or higher.

### TECHNICAL FIELD

The present invention relates to a removing agent capable of efficiently decomposing a fluorine-containing gas, in particular, a perfluoro compound (PFC) used for etching in manufacturing a semiconductor or the like or dry cleaning of a CVD apparatus without adding water or oxygen, and fixing fluorine as an alkaline earth metal fluoride in the removing agent, a manufacturing method thereof, a fluorine-containing gas removing method using the same, and a method of recovering a fluorine resource.

### BACKGROUND OF INVENTION

Fluorocarbons such as CHF₃ and PFCs such as CF₄, C₂F₆, C₄F₈, NF₃ and SF₆ are used as etching gases in the production of semiconductors and dry cleaning gases in chemical vapor deposition equipment. Since these are gases that promote global warming, they are required to be recovered and reused, and to be discharged after being decomposed into harmless gases having a low global warming potential. Among PFCs, perfluorocarbons are considered to be difficult to decompose and remove because they are chemically stable. In particular, C₂F₆ having a high global warming potential of over 10,000 times that of CO₂ is known as a gas particularly difficult to decompose, and a method of decomposing and removing it is strongly demanded.

In the following description, a fluorine-containing greenhouse such as fluorinated hydrocarbon and perfluoro compound (PFC) is called a fluorine-containing gas for simplification. Hydrogen fluoride (HF) produced by decomposition thereof is strictly a kind of fluorine-containing gas, but hydrogen fluoride is not included in the fluorine-containing gas for convenience of explanation.

Various methods have been put into practical use as a method for decomposing fluorine-containing gas. Among these methods, thermal decomposition using a firing furnace, decomposition using thermal plasma, hydrolysis using a catalyst requires addition of water or oxygen at the time of PFC treatment, and furthermore, it generates hydrogen fluoride as a reaction product, an ancillary facility for removing the hydrogen fluoride by post-treatment is required. As described above, in the above-mentioned conventional method, there is a problem in that the installation of the ancillary facility and the operation thereof have a large load for the hydrofluoric treatment.

On the other hand, a method of decomposing a fluorine-containing gas without adding water or oxygen and immobilizing the fluorine as an alkaline earth metal fluoride in a removing agent has also been proposed. As a removing agent used in the method, 1) the fluorine-containing gas can be decomposed at a temperature as low as possible, for example, 650° C. or less in order to avoid the use of expensive heat-resistant equipment and to reduce the running cost, 2) the bulk density of the removing agent is large and a large amount of exhaust gas can be treated even if the removing agent is filled in a small container, 3) the removing agent itself is excellent in environmental safety and does not contain heavy metals, 4) the recovery and recycling of fluorine which is a rare resource are easy, 5) the cost of the removing agent is low.

As such a removing agent, for example, materials based on aluminum oxide or zeolite are known. A system in which a zeolite is combined with an alkaline earth metal compound has an excellent removing ability, however still problems such as above 2) and 5) are held.

As an aluminum oxide-based removing agent, a system containing alumina and an alkaline earth metal oxide, or a removing agent containing an oxide of copper or chromium has been proposed (Patent Document 1). Patent Document 2 describes a removing agent of combination of γ alumina and lanthanum oxide. An example in which an alkaline earth metal oxide is used in place of lanthanum oxide is disclosed in Patent Document 3. However, this statement in order to decompose PFCs such as CF₄ using the removing agent described in the above, high temperatures of 800° C. or more are required. As it removes fluorine-containing gas to help prevent global warming, increasing energy consumption during operation and a decomposition treatment at high temperatures leading to increased CO₂ emissions are not preferred.

Among other examples of methods for immobilizing as an earth metal fluoride in a removing agent and decomposing fluorine-containing gas without adding water or oxygen, a removing agent containing aluminum hydroxide and calcium hydroxide and being capable of decomposing at a temperature of 550° C. to 850° C. is proposed as an agent capable of decomposing PFC at a relatively low temperature (Patent Document 4). This removing agent is characterized by decomposition of hydroxyl groups of aluminum hydroxide and use of the water resulting therefrom to remove fluorine-containing gases. This removing agent functions effectively in small volume processing such as laboratory scale, but there is a problem that the decomposition efficiency decreases when scaled up to a reactor of a practical size. As in this method, a removing agent for decomposing a fluorine-containing gas using water generated by decomposing a hydroxyl group at a reaction temperature has a problem that the removing agent cannot be used any more before the fluorine-containing gas flows in or if the hydroxyl group is lost during the treatment. That is, if the removing agent before use is exposed to a high temperature due to an error in control of the heater for heating the reactor, the hydroxyl group is lost due to thermal decomposition, and the fluorine-containing gas is in a state in which it cannot be decomposed when the fluorine-containing gas flows into the reactor, thereby causing a large risk of the fluorine-containing gas flowing out to the outside.

As a removing agent for solving such a problem, there have been proposed a removing agent capable of decomposing a fluorine-containing gas at a temperature of 550° C. to 850° C. (patent document 5), or a removing agent containing a zeolite having an acid point and an alkaline earth metal compound and being capable of decomposing at a temperature of 500° C. or more (patent document 6). However, the former operation temperature is as high as 750° C., and improvement is required. The latter exhibits high activity at relatively low temperatures, but because of the use of zeolites with low bulk density, the bulk density of the removing agent is also inevitably low. When a removing agent of a fluorine-containing gas is used, it is often used by being packed in an existing facility (reaction vessel), so that the amount of processing per one refill is lowered in the case of a removing agent having a small bulk density, which is not preferable in practical use. In addition, since zeolite is used, the raw material cost becomes high, and improvement thereof is required.

Removal agents containing heavy metals such as chromium, as in the case of the removing agent disclosed in Patent Document 1, are subject to anxiety in terms of environmental safety and require complicated separation operations when recovering calcium fluoride. Therefore, a removing agent composed of two metal elements, aluminum and alkaline earth metal as much as possible, is preferable.

Alumina raw materials include bayalite, gibbsite, nort strandite, etc. In addition to amorphous aluminum oxide, boehmite, pseudo-boehmite, α alumina, γ alumina, pseudo γ alumina, δ alumina, η alumina, θ alumina, κ alumina, ρ alumina, χ alumina and various structure could be generated depending on heating conditions when heating these raw materials. Among them, only amorphous aluminum oxide (Patent Document 5) and γ alumina (Patent Document 2) are described as structures related to the fluorine-containing gas removing agent, and the decomposition characteristics of the other crystal structures are not known. Further, these amorphous aluminum oxide and γ alumina do not meet the demand for improvement of the processing capacity.

As described above, when Example 1 of Patent Documents 1 to 6 are compared, it is shown as outline Table 1. As can be seen from these, in the prior art, there has not been found a removing agent which exhibits a high throughput at a relatively low temperature (e.g., 650° C. or less) and is low in cost in a state in which oxygen or water is not supplied from the outside.

TABLE 1
Comparison of patent documents 1 to 6.

| | | | | | | | Water or | | |
|---|---|---|---|---|---|---|---|---|---|
| | | | Second | | Alumina | Third | oxygen | Reaction | |
| | Patent | | metal | | crystalline | component | supply at | temp.: | |
| | document | Material | element | Calcination | structure | metal | treatment | ° C. | Problem |
| 1 | JP3789277 | Pseudo- | Ca | Yes | No | Yes (e.g. | Necessary | 650 | Oxygen supply |
| | | boehmite | | | description | Cu etc. in | | | necessary |
| | | | | | | Example | | | |
| | | | | | | 21-24) | | | |
| 2 | JP4156312 | Commercial | La | None | γ | None | Necessary | 860 | Steam and |
| | | alumina | | | | | | | oxygen supply |
| | | | | | | | | | necessary, high |
| | | | | | | | | | reaction temp. |
| 3 | JP2002- | Commercial | Ca | None | No | None | Necessary | 860 | Same above |
| | 224565 | alumina | | | description | | | | |
| 4 | JP5048208 | Aluminum | Ca | None | No | None | Unnecessary | 650 | Low throughput |
| | | hydroxide | | | description | | | | |
| 5 | JP5297208 | Amorphous | Ca | Yes | Amorphous | None | Unnecessary | 750 | Low |
| | | aluminum | | | aluminum | | | | throughput, |
| | | oxide | | | oxide | | | | high reaction |
| | | | | | | | | | temp. |
| 6 | JP2015- | Zeolite | Ca | None | — | — | Unnecessary | 650 | High material |
| | 33678 | | | | | | | | cost |

### PRIOR ART DOCUMENTS

### Patent Literature

### Patent Document 1: Japanese Patent No. 3789277

### Patent Document 2: Japanese Patent No. 4156312

### Patent Document 3: Japanese Patent Laid-Open No. 2002-224565

### Patent Document 4: Japanese Patent No. 5048208

### Patent Document 5: Japanese Patent No. 5297208

### Patent Document 6: Japanese Patent Laid-Open No. 2015-33678

### SUMMARY OF THE INVENTION

### Problems to be Solved by Invention

An object of the present invention is to provide a fluorine-containing gas removing agent having an enhanced exhaust gas removing capability, which efficiently decomposes fluorine-containing gas, particularly perfluoro compounds (PFCs) used for etching in manufacturing semiconductors and dry cleaning of CVD devices without using water or oxygen, and fixes fluorine as alkaline earth metal fluoride in the removing agent, a manufacturing method thereof, a fluorine-containing gas removing method using the same, and a method for recovering fluorine resources.

Other objects of the present invention will become apparent from the following description.

### Means for Solving the Problem

In view of the above-mentioned actual situation, the inventors of the present invention have carried out intensive research on the problem of improving the removal capability of the fluorine-containing gas removing agent in order to solve the drawbacks of the prior art. As a result, the following knowledge and guidelines were obtained as ideas for solving the problems of the present invention.

(1) Patent Document 6, which suggests the importance of the function as an acid catalyst in decomposing a fluorine-containing gas and immobilizing fluorine as an alkaline earth metal fluoride in a removing agent, was noted.
(2) Therefore, it was examined whether the decomposition characteristics of the fluorine-containing gas could be improved by using aluminum oxide having a large bulk density and a advantage of cost as a catalyst and controlling the acid properties thereof.
(3) Aluminum oxide is known to be amorphous or have various crystal phases, and to have acid properties corresponding thereto. However, there are only proposals of removal agents using some crystalline phases of aluminum oxide or an amorphous aluminum oxide (Patent Documents 2 and 5), it cannot be said that which crystal phase of aluminum oxide can be used to obtain a removal agent having a high fluorine-containing gas removal ability. Therefore, the inventors studied various kinds of crystalline alumina while correlating acid properties as a mixture with an alkaline earth metal compound with fluorine-containing gas decomposition properties.
(4) As a result, the removal agent containing η alumina and calcium oxide and the removal agent containing χ alumina and calcium oxide showed excellent ability of removing CF₄ under the low reaction temperature of 600° C. or less.
(5) Examination of the ammonia TPD-MS spectrum with a mass-to-charge ratio of 15 in the ammonia TPD-MS method for such highly active removing agent revealed a common feature with a shoulder in the region of 230-450° C. in addition to the ammonia desorption peaks centered at 180° C. On the other hand, no shoulders or peaks other than the main peak were observed in the removing agent containing γ-alumina having a low CF₄ removing capability. Therefore, the reason of high CF₄ removing capability is in the acid point corresponding to the shoulder of the TPD-MS spectrum at 230-450° C.
(6) Further, a removing agent having a high removing ability was obtained too when magnesium oxide was used instead of calcium oxide.
(7) The X-ray diffractive patterns of the removing agent containing η alumina and calcium oxide were examined by taking it out from the removing system while leaving the remaining capacity of the CF₄ decomposition treatment capacity. As a result, it was found that η alumina did not form a fluorine compound in the CF₄ decomposition process, and acts as catalysts for CF₄ decomposition reactions, and that an alkaline earth metal compound plays a function of fluorine immobilization.
(8) When the relationship between the composition ratio of aluminum and alkaline earth metal and the removing ability was examined, it was found that a removing agent having a high removing ability was obtained when the molar ratio of aluminum atom to alkaline earth metal atom was 1:9 to 5:5 for the removing agent containing η alumina and alkaline earth metal oxide. For removing agent containing χ alumina and alkaline earth metal oxide, the molar ratio of aluminum atom to alkaline earth metal atom was 2:8 to 5:5 to obtain a removing agent of high removing ability.
(9) Furthermore, it has been found that a removing agent containing η alumina and calcium oxide, and a removing agent containing χ alumina and calcium oxide can decompose and remove C₂F₆ having particularly high difficulty of decomposition among PFCs with high efficiency.
(10) In addition, χ alumina and x alumina both have high removal capabilities, but comparing their decomposition properties, η alumina exhibited higher fluorine-containing gas decomposition properties at low temperatures, which is more favorable, where the present invention has been achieved.

The present invention relates to:

1. A fluorine-containing gas removing agent comprising alumina and an alkaline earth metal compound, wherein ammonia desorption curves by an ammonia TPD-MS method of mass-to-charge ratio 15 have peaks in a range of less than 200° C. and have a shoulder in a range of 200° C. or more.
2. The removing agent according to the above 1, wherein the shoulder is present in the range of 230 to 350° C.
3. The removing agent according to the above 1 or 2, wherein at the ammonia TPD-MS spectrometry of the mass-to-charge ratio 15, the amount of ammonia desorbed at temperatures from 100 to 450° C. is 10.0 to 100.0 mmol/kg per weight of the removing agent.
4. The removing agent according to any one of the above 1 to 3, wherein at the ammonia TPD-MS spectrometry of the mass-to-charge ratio 15, the amount of ammonia desorbed at a temperatures in a range from 230 to 450° C. is 35.0 to 55.0 when the amount of ammonia desorbed at a temperature in a range from 100 to 450° C.
5. The removing agent according to any one of the above 1 to 4, wherein the alumina contains crystalline alumina.
6. The removing agent according to the above 5, wherein the crystalline alumina have a single peak at 2θ=45 to 47 in the X-ray diffraction pattern
7. The removing agent according to the above 5 or 6, wherein the crystalline alumina contains η alumina.
8. The removing agent according to the above 5, wherein the crystalline alumina have a peak at 2θ=42.6±0.5 in the X-ray diffraction pattern.
9. The removing agent according to the above 5 or 8, wherein crystalline alumina contains χ alumina.
10. The removing agent according to any one of the above 1 to 9, wherein the alkaline earth metal compound is at least one compound selected from the group consisting of magnesium oxide, calcium oxide, magnesium carbonate, calcium carbonate, calcium hydroxide and magnesium hydroxide.
11. The removing agent according to any one of the above 1 to 10, wherein the molar ratio of aluminum atoms to alkaline earth metal atoms is 1:9 to 5:5.
12. The removing agent according to any one of the above 1 to 11, wherein as aluminum atom is converted to an aluminum oxide (Al₂O₃) and the alkaline earth metal atom are converted to the alkaline earth metal oxide, the sum of the weight of the aluminum oxide and the alkaline earth metal oxide is 70 weight % or more based on the total weight of the removing agent.
13. The removing agent according to any one of the above 1 to 12, wherein the removing agent comprises no metal elements other than aluminum and alkaline earth metals.
14. The removing agent according to any one of the above 1 to 13, wherein the fluorine-containing gas is selected from the group consisting of a fluorinated hydrocarbon and a perfluoro compound.
15. The removing agent according to the above 14, wherein the fluoride hydrocarbon is selected from the group consisting of CHF₃, CH₂F₂, CH₃F, C₂HF₅, C₂H₂F₄, C₂H₃F₃, C₂H₄F₂ and C₂H₅F.
16. The removing agent according to the above 14 or 15, wherein the perfluoro compound is selected from the group consisting of CF₄, C₂F₆, C₃F₈, C₄F₁₀, C₄F₈, C₄F₆, C₅F₁₂, C₅F₁₀, C₅F₈, SF₆ and NF₃.
17. A method of manufacturing the removing agent of any one of the above 1 to 16, the method comprises steps of:

mixing and/or kneading η alumina and/or χ alumina with an alkaline earth metal compound and optionally a dispersion medium;

forming the resulting mixture; and

optionally drying and/or calcining the formed mixture.

18. A method of manufacturing the removing agent of any one of the above 1 to 16, the method comprises steps of:

mixing and/or kneading the bayalite and/or gibbsite with an alkaline earth metal compound and optionally a dispersion medium;

forming the resulting mixture and optionally drying; and

calcining the formed mixture.

19. The method according to the above 17 or 18, wherein the drying is performed at 100 to 150° C.
20. The method according to any one of 17 to 19 above, wherein the calcining is performed at 550 to 800° C.
21. A method of decomposing a fluorine-containing gas and immobilizing fluorine generated by decomposition in a removing agent, the method comprises steps of:

heating the removing agent according to any one of the above 1 to 16 at a temperature of 350 to 800° C.; and

inletting a fluorine-containing gas in the removing agent at a space velocity of 100 to 1000 h⁻¹ while maintaining the above-mentioned temperature.

22. The method of the above 21, wherein the temperature is 350 to 600° C.
23. A method of decomposing and removing a fluorine-containing gas, the method comprises step of: contacting a fluorine-containing gas with a removing agent according to any one of the above 1 to 16 without supplying water or oxygen from the outside.
24. A method of recovering fluorine from a fluorine-containing gas, the method comprises steps of:

decomposing a fluorine-containing gas by contacting the removing agent according to the above 13 and immobilizing fluorine generated from the decomposition in the form of an alkaline earth metal fluoride in the removing agent;

optionally grinding the fluorine immobilized removing agent to separate the alkaline earth metal fluoride and alumina; and

separating fluorine from the removing agent by treating the fluorine-immobilized removing agent or the alkaline earth metal fluorides obtained from grinding/separating the removing agent with a solution to dissolve the alkaline earth metal fluoride.

### Advantage of Invention

In accordance with the present invention,

(1) the fluorine-containing gas, in particular, the fluorine-containing gas discharged in the etching or cleaning gas process at the time of manufacturing a semiconductor or the like can be efficiently removed at a low temperature.
(2) no addition of water or oxygen is required to remove the fluorine-containing gas.
(3) since the fluorine in the fluorine-containing gas can be fixed in the removing agent as an alkaline earth metal fluoride, it is not necessary to provide an ancillary facility at the subsequent stage.
(4) energy cost and CO₂ emissions can be reduced because fluorine-containing gas decomposition is possible at low temperatures. Also, there is no need to use expensive refractory materials for the materials of the reactor, and there is no need to install expensive high power heaters.
(5) among fluorine-containing gases, perfluorocarbons which are persistent, and among them, C₂F₆ which is particularly persistent, can be removed with high efficiencies. Naturally, it can also be used to remove hydrofluorocarbons which are relatively easily decomposed.
(6) in order to cope with the increase in the amount of fluorine-containing gas emitted from emission sources due to the increase in the size of semiconductor facilities, etc., the removing agent of the present invention can be treated at high speed,
(7) it is also possible to provide a method in which fluorine can be easily separated and regenerated from the alkaline earth metal fluoride in the removing agent after the treatment. From the above, it is possible to provide a removing agent having excellent environmental safety and high recyclability, and a method of manufacturing the same, which were difficult for the conventional removing agents.

### BRIEF DESCRIPTION OF THE DRAWINGS

FIG. 1 Particle size distribution curve of the aluminum raw material used for the preparation of removing agent of each examples. Example 1 (Al raw material: bayalite), Example 5 (Al raw material: gibbsite), Comparative Example 2 (Al raw material: boehmite).

FIG. 2 X-ray diffraction pattern of Example 2, Example 6, Comparative Example 2 and Comparative Example 1

FIG. 3 Enlarged view of FIG. 2 focusing on the low diffraction intensity region of Example 2, Example 6, Comparative Example 2, Comparative Example 1

FIG. 4 Difference spectrum between Example 2 (crystalline alumina+calcium oxide) and Comparative Example 1 (calcium oxide)

FIG. 5 Shape comparison of the diffraction peaks (2θ=44.0° to 48.0°) for Example 2 and Comparative Example 2

FIG. 6 Difference spectrum between Example 6 (crystallic aluminum+calcium oxide) and Comparative Example 1 (calcium oxide)

FIG. 7 X-ray diffractive patterns of analysis example 7 (in-progress product of Example 2 for evaluating CF₄ removing capability)

FIG. 8 Ammonia TPD-MS spectra of Example 2, Example 6, and Comparative Example 2

### DETAILED DESCRIPTION OF THE INVENTION

The present invention is a removing agent which decomposes a fluorine-containing gas and fixes to removes fluorine produced by the decomposition as an alkaline earth metal fluoride containing alumina having specific acid properties, preferably crystalline alumina and an alkaline earth metal compound. In this specification, from the viewpoint of decomposing and removing the fluorine-containing gas by treating the gas with the above agent, “removing agent” is also called “decomposition removing agent” and “treatment agent”.

As described above, the removing agent comprises an alkaline earth metal compound. The alkaline earth metal is selected from the group consisting of beryllium, magnesium, calcium, strontium, barium and radium, preferably magnesium or calcium. Alkaline earth metal compounds which can be used in the present invention include, for example, oxides, carbonates and hydroxides of alkaline earth metals, preferably oxides, among which, for example, calcium oxide, calcium carbonate, calcium hydroxide, magnesium oxide, magnesium carbonate and/or magnesium hydroxide, particularly preferably calcium oxide and/or magnesium oxide, are used.

In the following, for the sake of simplicity, embodiments using calcium oxide as the alkaline earth metal compound are described in detail. The descriptions of these embodiments are also applicable to other embodiments employing alkaline earth metal compounds other than calcium oxide, and those skilled in the art will be able to properly understand other embodiments by reference to these descriptions.

As described above, the fluorine-containing gas removing agent of the present invention comprises alumina having specific acid properties. Whether or not the alumina (preferably crystalline alumina) comprised in the fluorine-containing gas removing agent has a particular acid property is determined by shape of the ammonia desorption curve (curve plotting the ion current value against temperature) obtained by ammonia TPD-MS method (using a signal having a mass-to-charge ratio of 15, which is a fragment of ammonia), as explained in the examples. The shape is characterized by having a peak in the range of less than 200° C. and a shoulder in the range of 200° C. or more, as shown in FIG. 8 (Example 2 or 6). Preferably, the ammonia desorption curve has a peak in a range from 160° C. to less than 200° C., more preferably in a range centered at 180° C., e.g., 170 to 190° C., and a shoulder in a range from 230 to 450° C., more preferably in a range from 240 to 400° C., and particularly preferably in a range from 250 to 350° C., e.g., 250 to 340° C., 250 to 330° C., or 250 to 320° C.). Here, preferably the peak is the main peak, that is, the peak with the largest ion current value in the curve. Preferably, the peak can be a single peak in the curve, except for a shoulder. In addition, the above-mentioned ammonia desorption curve may have one or more shoulders, but preferably has one shoulder.

In the present specification, the “peak” represents a convex apex portion of the ammonia desorption curve.

In the present specification, the term “shoulder” denotes a shoulder or stepped portion in the ammonia desorption curve, i.e., a relatively short portion projecting transversely to a smooth curve slope in the curve.

In other words, the ammonium TPD-MS spectrum has the above peaks, and further has an inflection point in the range of 200° C. or more, preferably in the range of 240 to 300° C., more preferably 250 to 290° C., in particular 260 to 280° C.

In the present specification, “inflection point” represents a point at which the slope of the tangent line at a point of the ammonia desorption curve changes from an increase to a decrease, or a point at which the slope of the tangent line changes from a decrease to an increase. In one preferred embodiment of the present invention, the ammonia desorption curve has the former, i.e. an inflection point at which the slope of the tangent changes from increasing to decreasing, in the above temperature range.

Therefore, in one embodiment of the present invention, the ammonia desorption curve has a main peak in a range of 160° C. or more and less than 200° C., preferably in a range centered around 180° C., and the ion current value decreases toward a higher temperature side than the peak, in order to have the above-mentioned inflection point (the point at which the slope of the tangent at a certain point of the ammonia desorption curve starts to increase to decrease) in the range of 200° C. or more, in particular, in the range of 260 to 280° C., the above-mentioned shoulder is formed within a specific temperature range. Typically, as shown in FIG. 8 (Examples 2 and 6), the ion current value increases from around 100° C. to reach the main peak value, but the ion current value decreases from this main peak to the high temperature side and decreases to 0 (or around 0) in the temperature range of over 400° C. Then, one shoulder as described above is formed until the ion current value decreases from the main peak value to 0 (or near 0).

The shoulder may have a sharp shape or may be gentle as long as there is any portion to be recognized as a shoulder compare to a curve having only the main peak (e.g., Comparative Example 2 of FIG. 8).

The above ammonia desorption curve can have other inflection point other than the above temperature range as long as the above-mentioned shoulder is formed.

In one embodiment of the present invention, the ion current value at the inflection point (the point at which the slope of the tangent line at a point of the ammonia desorption curve changes from an increase to a decrease) can be 10 to 80%, preferably 30 to 75%, for example 50 to 70% of the ion current value of the peak.

As described above, the fluorine-containing gas removing agent of the present invention comprises an alumina having specific acid properties, that is, an alumina having the characteristics described above in the ammonia desorption curve of the removing agent containing the alumina. Preferably, the alumina is a crystalline alumina.

The fluorine-containing gas removing agent of the present invention is required compatibility of decomposition activity at low temperature and high removal capability. In the present invention found that the removing agent could have both decomposition activity at low temperature and high removal capability when the amount of desorbed ammonia per weight of the removing agent (the amount of desorbed ammonia per 1 kg of removing agent) is 5.0 to 150 0 mmol/kg, preferably 7.0 to 120 0 mmol/kg, particularly preferably 10.0 to 100.0 mmol/kg when the amount of ammonia desorbed in the range of 100 to 450° C. is determined by ammonia TPD-MS spectrum. As will be described later, the above-mentioned alumina, preferably crystalline alumina, functions as a catalyst, and calcium oxide functions to fix fluorine as calcium fluoride. The small amount of desorbed ammonia per weight of the removing agent indicates that the number of acid points which can be the active center of the catalyst is small, which leads to a decrease in the fluorine-containing gas decomposition rate. On the other hand, it is also important for the present removing agent that the fixing (removing) ability of fluorine generated by decomposition is high. For this purpose, it is necessary to increase the calcium oxide content as much as possible. Excessively high amounts of desorbed ammonia per weight of removing agent lead to a sacrifice in calcium oxide content. Therefore, the amount of desorbed ammonia per weight of the removing agent is preferably controlled within a range suitable for maximizing the decomposition and removal ability of the removing agent.

In the case of the present removing agent in which alumina (preferably crystalline alumina) has a specific acid property, which is compatible with the fluorine-containing gas decomposition activity at a low temperature and the removing ability, in addition to a peak (preferably a main peak) centered at less than 200° C., preferably 180° C., it has a shoulder in the range of 230 to 450° C. Since the removing agent containing alumina having such shoulder, preferably crystalline alumina, exhibits excellent performance, it is presumed that the acid point which forms the shoulder is the active center of the fluorine-containing gas decomposition reaction. In the case of such removing agent, it is found in the present invention that in the ammonia TPD-MS spectrum with a mass-to-charge ratio of 15, the amount of ammonia desorbed from the shoulder from 230 to 450° C. is 35 to 55, for example 40 to 50, when the amount of ammonia desorbed from 100 to 450° C. is set to 100.

The alumina contained in the fluorine-containing gas removing agent having the above-mentioned characteristics in the ammonia desorption curve is preferably crystalline alumina as described above. Preferably, the type of crystalline alumina included in the fluorine-containing gas removing agent having the above characteristics in the ammonia desorption curve is η alumina and/or χ alumina. Accordingly, in one embodiment of the present invention, the alumina may comprise η alumina and/or χ alumina. In a further embodiment of the invention, the alumina consists essentially only of η alumina and/or χ alumina.

The fluorine-containing gas to be decomposed (to be removed) by the removing agent of the present invention is not particularly limited as long as to be a gas comprising alone or in combination of fluorinated hydrocarbons such as CHF₃, CH₂F₂ and CH₃F, and PFCs such as CF₄, C₂F₆, C₄F₈, NF₃ and SF₆. In one embodiment, the fluorine-containing gas comprises CF₄ and/or C₂F₆, or is a gas consisting of CF₄, C₂F₆, or CF₄ and C₂F₆. In the following, for the sake of brevity, the embodiments in which the removing agent using crystalline alumina and calcium oxide and the CF₄ is subject to decomposition is mainly described in detail.

The reaction formula for removing fluorine-containing gas by the removing agent of the present invention is represented by (1) to (3) as an example when the alkaline earth metal is calcium oxide and the fluorine-containing gas is CF₄. In formula (1) to (3), “ads” at the lower right of the molecular formula represents a state adsorbed on the surface of crystalline alumina. Among them, it is presumed that the reaction (1) is such that a specific acid point on the surface of the crystalline alumina particle becomes an active center, and the reaction (2) and (3) proceeds at the interface between the crystalline alumina and calcium oxide.

CF₄→C_{ads}+4F_{ads} (1)

CaO+2F_{ads}→CaF₂+O_{ads} (2)

C_{ads}+2O_{ads}→CO₂ (3)

It can be seen that crystalline alumina is indispensable as a decomposition catalyst of the formula (1) and affect removing ability since the calcium oxide fixes fluorine as calcium fluoride. That is, it can be said that the crystalline alumina and calcium oxide play different roles. As a whole, it proceeds as formula (4).

CF₄+2CaO→2CaF₂+CO₂ (4)

As mentioned above, the removing agent of the present invention comprises the above-mentioned alumina and alkaline earth metal compound, wherein the ratio of the number of aluminum atoms to the number of alkaline earth metal atoms in the removing agent is preferably 0.1:99.9 to 8:2, more preferably 0.5:99.5 to 6:4, particularly preferably 1:9 to 5:5, for example 1.5:8.5 to 5:5 or 2:8 to 5:5. When the number of aluminum atoms and the number of alkaline earth metal atoms are in this range, particularly good fluorine-containing gas decomposition activity at low temperature and removal ability can be compatible. In addition, when the raw material is input to the kneader as described below, the amount of raw material used is measured based on this ratio.

The total weight of alumina and alkaline earth oxide in the present removing agent is from 50 to 100% by weight, more preferably from 60 to 100% by weight, particularly preferably from 70 to 100% by weight, for example from 80 to 100% by weight or from 90 to 100% by weight, based on the total weight of the removing agent, when calculated assuming that the all aluminum atoms in the removing agent are present as aluminum oxides (Al₂O₃) and all alkaline earth metal atoms are present as their oxides (CaO in the case of Ca, MgO in the case of Mg).

Particularly good removal capabilities can be obtained when the sum of the weights of aluminum oxide and alkaline earth metal oxide based on the total weight of the removal agent, is in this range. In addition, when the raw material is input to the kneading machine as described below, the amount of raw material used is measured based on this ratio.

In one embodiment of the present invention, the removing agent of the present invention does not comprise metal elements other than aluminum and alkaline earth metals. In this case, the removing agent has the advantage that a complicated operation is not required to recover the calcium fluoride. The removing agent may contain other components, for example, a dispersion medium, a molding aid, and the like, as long as the effects of the present invention are not impaired. In another embodiment of the present invention, the removing agent of the present invention may consist substantially only of alumina and alkaline earth metal oxides.

The removing agent may also have tap densities of 0.5 to 1 g/ml, preferably 0.6 to 0.9 g/ml, for example 0.7 to 0.85 g/ml. The removing agent having such tap densities are capable of achieving sufficient throughput of fluorine-containing gases.

Hereinafter, a method for producing the fluorine-containing gas removing agent of the present invention is explained.

For example, the removing agent can be produced by mixing the alumina with the alkaline earth metal compound (or a raw material of the alkaline earth metal compound), forming the resulting mixture, and optionally drying and/or calcining. Alternatively, the removing agent can be produced by mixing the raw material of the alumina with the raw material of the alkaline earth metal compound, forming the resulting mixture, optionally drying, and calcining.

The above-mentioned alumina, preferably crystalline alumina, e.g. η alumina or χ alumina, can be prepared, e.g. by calcination, from the raw materials to generate the above-mentioned alumina. For example, in the case of η alumina or χ alumina, bayerite or gibbsite, respectively, can be used as the raw material. Bayerite as a raw material of η alumina can be, for example, PURAL BT from SASOL Corporation, and gibbsite as a raw material of χ alumina can be, for example, CW-350 from Sumitomo Chemical Corporation. The raw material of the alumina may preferably have a median diameter of 45 μm or less, for example 20 to 45 μm.

The alkaline earth metal compounds described above, such as calcium oxide or magnesium oxide, are commercially available or can be prepared from raw materials that yield the alkaline earth metal compounds described above, for example, by calcination. For example, in the case where the alkaline earth metal compound is calcium oxide or magnesium oxide, calcium hydroxide or magnesium hydroxide can be used as a raw material. The calcium hydroxide as a raw material of the calcium oxide of the present invention can be, for example, JIS special number slaked lime from Ube Materials Co., Ltd. Since the removing agent of the present invention is typically produced through a paste state in a manufacturing process as shown in the examples below, the raw material in powder form that is easy to handle is preferable.

In one embodiment, the present invention relates to a method of the above mentioned fluorine-containing gas removing agent, the method comprises steps of:

mixing and/or kneading the said alumina (preferably η alumina and/or χ alumina) with an alkaline earth metal compound (preferably calcium oxide and/or magnesium oxide) and optionally a dispersion medium;

forming the resulting mixture; and

optionally drying and/or calcining the formed mixture.

In another embodiment of the present invention, the present invention relates to a method of manufacturing the fluorine-containing gas removing agent, the method comprises steps of:

preparing the said alumina (preferably η alumina and/or χ alumina) by calcining the said alumina raw material (preferably bayalite and/or gibbsite),

mixing and/or kneading the obtained alumina (η alumina and/or χ alumina) with an alkaline earth metal compound and optionally a dispersion medium;

forming the resulting mixture; and

optionally drying and/or calcining the formed mixture.

In a further embodiment of the present invention, the present invention relates to the method of manufacturing the above said removing agent, the method comprises the steps of:

mixing and/or kneading the above said alumina raw material (preferably bayalite and/or gibbsite) with an alkaline earth metal compound (preferably calcium hydroxide and/or magnesium hydroxide) and optionally dispersing with a medium;

forming the resulting mixture and optionally drying; and

calcining the formed mixture.

The present invention also relates to a fluorine-containing gas removing agent produced by the method.

In the mixing and/or kneading step described above (hereinafter also referred to simply as “kneading” collectively), a dispersion medium may be used. Water is suitably used as the dispersion medium, and an organic solvent such as an alcohol or other additives may be used too if necessary. The mixing and/or kneading can be carried out by the methods commonly used in the art (in particular those used for mixing powders), for example using a kneader. The kneader is not particularly limited as long as it can uniformly mix the powder, such as a ribbon blender, a kneader, a mix muller, or a mortar machine.

Mixed and/or kneaded raw materials (i.e., the resulting mixture/kneaded product, hereinafter, also simply referred to as “the mixture obtained”) can then be formed.

When the removing agent is used in powder form the fluorine-containing gas removing ability of the removing agent may be significantly impaired as the contact between the alumina particles (preferably crystalline alumina particles) responsible for the fluorine-containing gas decomposition reaction and the calcium oxide particles responsible for fluorine immobilization is weak, mass transfer at the interface between the two particles is hindered. In order to facilitate mass transfer at the interface between the alumina particles (preferably crystalline alumina particles) and the calcium oxide particles in the fluorine-containing gas removal reaction, it is preferable to consolidate the kneading raw material with an appropriate mechanical load strength and to impart a form to the removing agent. Thus, in one embodiment of the present invention, the removing agent is in the form of a shaped body.

The shape and size of the removing agent of the present invention can be appropriately selected depending on its use mode, but generally, granules or cylindrical pellets having a diameter of 1 to 5 mm and a length of about 3 to 20 mm are suitably used. However, the present invention is not limited thereto, and various different shapes of pellets, tablet shapes, granules, crushed granules, and the like can be used. For this purpose, any molding equipment capable of consolidating the obtained mixture can be used without any particular limitation, for example, a tablet press, a briquette machine, a pelletizer, a disk pelleter, a plunger extruder, or the like can be used as the molding machine.

It is also possible to use a kneading molding machine to complete the mixing and molding of the kneading raw materials in one equipment.

The shaped removing agent can then be dried. η-alumina and χ-alumina which can be used as components of the removing agent of the present invention, and bayerite and gibbsite which can be used as aluminum raw materials for the alumina could form boehmite under a hydrothermal condition. In addition, bayerite and gibbsite could form a complex hydroxide under a hydrothermal condition in admixture with calcium hydroxide.

Since γ-alumina produced at the boehmite calcination and the complex oxides produced at the complex hydroxides have a low CF₄ removing capability, the materials after kneading need to be dried under conditions in which they are not produced. Drying temperature for that purpose is preferably from 50 to 200° C., more preferably from 60 to 170° C., still more preferably from 80 to 160° C., particularly preferably from 100 to 150° C., for example from 10 to 130° C. The drying time is preferably from 1 minute to 30 minutes, more preferably from 2 minutes to 15 minutes, particularly preferably from 3 minutes to 10 minutes, for example from 3 minutes to 5 minutes. If the time is too short, residual moisture may adversely effect at the firing process forming γ-alumina and complex oxides. If the drying time is too long, water vapor in the dryer may be contacted for a long time to form boehmite and complex hydroxides.

The dryer can be selected from a mesh belt oven, a rotary dryer, an infrared heat dryer, a hot air circulation type dryer or the like without any particular limitation. However, for the reasons described above, it is preferable to select an apparatus capable of reducing the concentration of retained water vapor in the furnace, and to operate the apparatus under conditions suitable for the apparatus.

The formed removing agent, preferably a removing agent dried after forming, can then be calcined. The precautions to be taken during drying also apply to calcination. The calcination can be carried out, for example, in an air atmosphere. The η alumina and χ alumina that can be used as components of the removing agent of the present invention, as well as the bayalite and gibbsite that can be used as aluminum raw materials for the alumina, can all form boehmite under hydrothermal conditions. In addition, bayerite and gibbsite form complex hydroxides when mixed with calcium hydroxide and subjected to hydrothermal conditions. γ-alumina oxide formed in the firing of boehmite and the complex oxide produced by complex hydroxides calcination have a low CF₄ removing capability, a firing condition not to produce them is required.

If the firing temperature is too low, it becomes a removing agent containing a large amount of calcium hydroxide, a water-rich exhaust gas (off-gas) is discharged when being filled into a reaction vessel actually used and heated, which becomes a source of trouble in the post-stage equipment. If the firing temperature is excessively high, crystal components such as α alumina, κ alumina, and θ alumina, which are not preferable for the present invention, are increased. Therefore, the firing temperature is preferably 450 to 900° C., more preferably 500 to 850° C., particularly preferably 550 to 800° C., for example 650 to 750° C.

The firing time is preferably 10 minutes to 90 minutes, more preferably 15 minutes to 50 minutes, particularly preferably 20 minutes to 40 minutes. If the time is too short, the calcium hydroxide content becomes high to cause the same trouble as when the calcination temperature is low. If the time is too long, the aluminum raw material may form a composite oxide via γ alumina or a composite hydroxide via boehmite as it comes into contact with the water vapor in the furnace for a long time.

The furnace can be selected from a mesh belt furnace, a rotary kiln, an infrared heating furnaces and the like without any particular limitation. However, for the reasons described above, it is favorable to select a device capable of lowering the concentration of retained water vapor in the furnace, and to operate it under conditions suitable for that.

As described above, the fluorine-containing gas removing agent of the present invention can be produced.

By using a removing agent produced in this manner, specifically, the removing agent can be in contact with a fluorine-containing gas, typically by maintaining its contact state, to decompose the fluorine-containing gas to fix the generated fluorine in the removing agent, and consequently to remove the fluorine-containing gas.

Devices in which the removing agent of the present invention is used comprises, for example, moving beds and fluidized beds, and usually used in fixed beds. Further, the details of the structure of these devices are not particularly limited. As a specific example, the removing agent of the present invention is filled in, for example, a cylindrical reaction vessel, and the exhaust gas containing fluorine-containing gas is flown therethrough, whereby the fluorine-containing gas in the exhaust gas can be removed safely and efficiently.

The removal of the fluorine-containing gas to be treated and removed by the removing agent of the present invention can be carried out on an exhaust gas comprising a fluorine-containing gas of, for example, 0.01 ppmv (parts per million by volume) to 100 vol. %, preferably from 1 ppmv to 10 vol. %, more preferably from 1 ppmv to 5 vol. %; and/or at reaction temperature of 800° C. or less, preferably 350 to 800° C., more preferably 350 to 720° C., even more preferably 350 to 600° C., for example 400 to 580° C. or 460 to 580° C.; and/or at a removing agent layer thickness of 1 to 1000 cm, for example 50 cm to 300 cm; and/or at a space velocity of fluorine-containing gas of 1 to 2000 h⁻¹, for example 100 to 1000 h⁻¹. With respect to the above-mentioned reaction temperature, for example, when the object to be removed is CF₄, when a removing agent containing η alumina is used as the alumina, it is possible to perform removal at preferably 350 to 800° C., more preferably 350 to 720° C., still more preferably 350 to 600° C., for example 400 to 520° C., and when a removing agent containing χ alumina is used as the alumina, it is possible to perform removal at preferably 400 to 800° C., more preferably 450 to 720° C., still more preferably 480 to 600° C., for example 500 to 580° C. On the other hand, for example, when the object to be removed is a C₂F₆, when using a removing agent containing η alumina as the above alumina, it is possible to perform removal at preferably 350-800° C., more preferably 350 to 720° C., for example 500 to 620° C., and when using a removing agent containing χ alumina as the above alumina, it is possible to carry out the removal at preferably 350 to 800° C., for example 600 to 720° C.

When the removing agent of the present invention is used, the fluorine-containing gas can be removed without supplying water or oxygen from the outside of the reaction system.

Thus, in one embodiment of the present invention, the present invention relates to a method of treating a fluorine-containing gas, preferably a method of decomposing a fluorine-containing gas, more preferably a method of decomposing a fluorine-containing gas and immobilizing fluorine produced by decomposition in a removing agent (preferably in the form of an alkaline earth metal fluoride), the method comprises steps of:

heating the above said removing agent at a temperature of 350 to 800° C.; and

inletting a fluorine-containing gas in the removing agent at a space velocity of 100 to 1000 h⁻¹ while maintaining the above-mentioned temperature.

Preferably, in the method, neither water nor oxygen is supplied from outside. By this method, for example, the fluorine-containing gas in the exhaust gas is decomposed and the fluorine-containing gas is removed from the exhaust gas.

In another embodiment of the present invention, the invention relates to the use of said removing agent for treating a fluorine-containing gas, preferably for decomposing a fluorine-containing gas, more preferably for decomposing a fluorine-containing gas and immobilizing fluorine produced by decomposition in a removing agent (preferably in the form of an alkaline earth metal fluoride).

In another embodiment of the present invention, the invention relates to a method recovering fluorine from a fluorine-containing gas, the method comprises steps of:

heating the removing agent at temperature of 350 to 800° C.,

decomposing a fluorine-containing gas by inletting a fluorine-containing gas in the removing agent at a space velocity of 100 to 1000 h⁻¹ while maintaining the above-mentioned temperature, and immobilizing fluorine generated by decomposition in the removing agent preferably in the form of an alkaline earth metal fluoride;

optionally grinding the fluorine immobilized removing agent to separate the alkaline earth metal fluoride and alumina; and

separating fluorine from the removing agent as hydrogen fluoride by treating the fluorine-immobilized removing agent or the alkaline earth metal fluorides obtained from grinding/separating the removing agent with a sulfuric acid solution to dissolve the alkaline earth metal fluoride. Preferably, in the method neither water nor oxygen is supplied from the outside. By the method the useful resource fluorine can be recovered from the fluorine-containing gas. In particular, this method is advantageous when the removing agent does not contain metal elements other than aluminum and alkaline earth metals.

In a further embodiment of the present invention, the present invention relates to the use of said removing agent for recovering fluorine from a fluorine-containing gas.

The end point of use of the removing agent of the present invention can be achieved by monitoring the concentration of the fluorine-containing gas in the gas discharged from the removing agent. The removing agent determined to have reached the throughput limit is removed from the apparatus and disposed. As a disposal method, a treatment solution capable of selectively dissolving only alkaline earth metal fluorides, for example, immersed in a sulfuric acid to recover as hydrogen fluoride. In addition to harvesting, only alkaline earth metal fluoride can be taken out from a mixture of alkali metal fluoride and alumina having different specific gravities and particle diameters, which is obtained by crushing a removing agent judged to have reached the limit of the throughput, by using a gravity concentrating method or a elutriation method, and hydrogen fluoride can be recovered by immersing in sulfuric acid. Also, it can be simply discarded.

The following examples are provided to illustrate the present invention in detail, but not limited in any way.

### EXAMPLES

Physical property evaluation and performance evaluation of the removing agent used in the following Examples and Comparative Examples were carried out by the following methods.

(1) Particle Size Distribution Measurement: A laser diffraction scattering particle size distribution measuring device, Model Micro79 Track MT3300EX from Microtrack-Bell Co., Ltd. was used. Solvent was water (refractive index: 1.333), and the properties to be measured were aspherical, transmission, refractive index: 1.81.
(2) Tap Density Measurement: 70 g of removing agent was filled in a 100 ml cylinder and read the removing agent fill volume after 100 taps, tap density (g/ml) was determined. The instrument used was according to a model Autotap manufactured by Qantachrome Instruments Japan.
(3) X-ray diffraction measurement: X-ray diffraction method with CuKα radiation (45 kV, 40 mA) by using model X'Pert PRO MPD from Spectris Co., Ltd. The detector was X'Celerator (one-dimensional silicon strip detector) also from the same company. In addition, a 1° divergent slit and a 0.04 rad solar slit were attached. In the scan of 2θ=20 to 70°, the step size was 0.017°, the scan speed was 0.060°/sec. In the scan of 2θ=44 to 48°, the step size was 0.00 2°, and the scan speed was 0.004°/sec.
(4) CF₄ removal capacity evaluation: The removing agent of 31.4 ml (layer thickness: 10.0 cm) was filled in a 2.0-cm ID reactor made of high-corrosion-resistant nickel-alloy (Hastelloy) installed in a ceramics electrotubular oven and used for the evaluation. Dry N₂ gas was passed through the reactor at a space velocity (GHSV) of 502 h⁻¹, and the temperature was raised to the test reaction temperature over a period of 3 hours, and then the temperature was maintained. The overshoot at the time of temperature rise was controlled within 20° C. After 30 minutes when the test temperature stabilized, the gas flowing into the reactor was switched to a dry N₂ gas (GHSV: 502 h⁻¹) containing 1.00 vol. % of CF₄ gas. The time from the start of the flow of the CF₄ gas into the reactor to the detection of the CF₄ gas of 500 ppmv in the processed gas (decomposition rate: 95%) was defined as the CF₄ gas treatment time, and the CF₄ removing capacity (L/kg) was estimated using the equation (5). A gas chromatograph with a thermal conductivity detector (TCD) (GC-2014, Shimadzu Co., Ltd., packed column filler: Porapack Q, carrier gas: He) was used to measure CF₄ concentration and other reaction products in the decomposition processed gas. With respect to all the test specimens, when a CF₄ gas of 500 ppmv was detected in the processed gas, it was confirmed that F2 and HF gases were not present in the processed gas by using a detection tube (No. 17) from Gastec Corporation. For the decomposition gas detected in the processed gas was only CO₂ except for N₂.

[Chemical Formula 1]

CF₄ removal capacity (L/kg)=space velocity (502 h⁻¹)×CF₄ concentration (1.00 vol. %)×CF₄ gas treatment time (h)/tap density (kg/L) (5)

(5) Evaluation of C₂F₆ removal capacity evaluation: The evaluation was carried out by the same facilities and procedures as the evaluation of CF₄ removal capacity, except that dry N₂ containing 0.67 vol. % of C₂F₆ gas was used for the test. The time till detect 333 ppmv of C₂F₆ in the processed gas (decomposition rate: 95%) was defined as the C₂F₆ gas treatment time, and the C₂F₆ removing capacity was estimated using equation (6). The reason why the concentration of the decomposition rate C₂F₆ gas was set to 0.67 vol. % was that the concentration of fluorine atoms per unit gas volume in the CF₄ test and the C₂F₆ test were the same. With respect to all the test specimens, when a C₂F₆ gas of 333 ppmv was detected in the processed gas, it was confirmed that F₂ and HF gases were not present in the processed gas by using a detection tube (No. 17) from Gastec Corporation. For the decomposition gas detected in the processed gas was only CO₂ except for N₂. The decomposition gases detected in the natural gas were CO₂ and CO, except for N₂.

[Chemical Formula 1]

C₂F₆ removal capacity (L/kg)=space velocity (502 h⁻¹)×C₂F₆ concentration (0.67 vol. %)×C₂F₆ gas treatment time (h)/tap density (kg/L) (6)

(6) Effect of Reaction Temperature on CF₄ Decomposition Rate: The removing agent of 31.4 ml (layer thickness: 10.0 cm) to be tested was filled in a Hastelloy reactor with an inner diameter of 2.0 cm installed in a ceramic electrotubular oven and used for evaluation. In the test, 15 steps of temperature raising operation were performed at 30° C. intervals from 300° C. to 720° C. In the respective temperature step, when the temperature became constant, dry N₂ (GHSV: 502 h-1) containing 1,000 ppmv of CF₄ gas was flown in, and after 15 minutes the CF₄ concentration on the inlet side of the reactor gas and after 30 minutes the CF₄ concentration on the outlet side of the reactor gas were examined. Equation (7) was used to calculate the CF₄ decomposition rate. The gas chromatograph with a TCD detector (GC-2014, Shimadzu Co., Ltd., packed column filler: Porapack Q, carrier gas: He) was used for CF₄ concentration. The dry N₂ gas (GHSV: 502 h⁻¹) was circulated during the period the 1,000 ppmv CF₄ gas was not circulated when the temperature was not stable during the period of the temperature rise and the temperature hold thereafter.

CF₄ decomposition rate (%)=[inlet gas CF₄ concentration (ppmv)−processed gas CF₄ concentration (ppmv)]/inlet gas CF₄ concentration(ppmv)×100 (7)

(7) Ammonia TPD-MS measurements: Measured with a catalytic analyzer model BELCAT-B from Microtrack Bell Co., Ltd. A mass-spectrometer was OmniStar GSD301 O₂ from Pfeiffer Vacuum Inc. In order to avoid overlapping of the signals caused by water and CO₂ fragments (mass-to-charge ratio 16 and 17), mass-to-charge ratio 15 of the ammonium fragment was used for data analysis. The sample to use in the test was quickly crushed with agate mortar and pestle to prevent exposure to the outside air. Approximately 100 mg of sample was placed in the sample cell and used for the measurement. As a pretreatment for the measurement, the temperature was maintained at 500° C. for 60 minutes under a He gas flow at a flow rate of 50 ml/min, and then, 5% ammonia-He at temperature of 100° C. and flow rate of 50 ml/min was circulated for 30 minutes for ammonia adsorption. After switching to a He gas of the flow rate 30 ml/min and holding for 30 minutes, the ammonia desorption curve was obtained of between 100 to 450° C. while rising the temperature at rate of 10° C./min from 100° C. up to 610° C. When the temperature reached 610° C., the temperature was held for 10 minutes to terminate the measurement.

In determining the amount of desorbed ammonia (unit: mmol/kg) per weight of the removing agent, the weight of the removing agent after the ammonia TPD-MS measurement above was used for the calculations. The removing agent weight was determined by subtracting the previously determined empty sample cell weight from the sample cell weight after the ammonia TPD-MS measurement.

### Example 1

Preparation of a removing agent sample comprising η alumina and a calcium oxide is as follows. Bayerite (Al(OH)₃) powder and a calcium hydroxide powder were weighed so that the molar ratio Al(OH)₃:Ca(OH)₂ was 5:5, made a kneaded cake (mixture) by mixing in a mix muller (Shinto Kogyo Co., Ltd., Model MSG-0LS) while adding water. Disk Peletor (Non-2 Paudal Co., Ltd., Model F-5) was used to make the kneaded cake in a grain shape of a diameter approximately 2 mm and a length about 6 mm. The obtained grain shape was dried for 5 minutes in a hot air circulation type electric dryer maintained at 120° C. The dried grain shape was calcined in a rotary kiln (an external heat batch type rotary kiln from Takasago Kogyo Co., Ltd.) under a flow of dry air (dew point: −50° C.) of 50 L/min while rotating the retort at 1.5 rpm. The calcining was carried out by holding 700° C. for 30 minutes. The removing agent sample was obtained of Example 1 after cooling to room temperature by operating a cooling blower attached to the rotary kiln.

The resulting sample was stored in a desiccator containing silica gel and taken out at various tests. The tap density and the CF₄ removing agent capacity at the test temperatures of 600° C. are shown in Table 2. The results of analysis on the amount of desorbed ammonia per weight of the removing agent obtained by the ammonia TPD-MS measurement are shown in Table 3.

### Example 2

A removing agent sample of Example 2 of the molar ratio Al(OH)₃:Ca(OH)₂ of 3:7 was prepared and stored in the same method and conditions of Example (Ex.) 1. The tap density and the CF₄ removing agent capacity at the test temperatures of 600° C. are shown in Table 2. The results of analysis on the amount of desorbed ammonia per weight of the removing agent obtained by the ammonia TPD-MS measurement are shown in Table 3.

### Example 3

A removing agent sample of Example 3 of the molar ratio Al(OH)₃:Ca(OH)₂ of 2:8 was prepared and stored in the same method and conditions of Example 1. The tap density and the CF₄ removing agent capacity at the test temperatures of 600° C. are shown in Table 2. The results of analysis on the amount of desorbed ammonia per weight of the removing agent obtained by the ammonia TPD-MS measurement are shown in Table 3.

### Example 4

A removing agent sample of Example 4 of the molar ratio Al(OH)₃:Ca(OH)₂ of 1:9 was prepared and stored in the same method and conditions of Example 1. The tap density and the CF₄ removing agent capacity at the test temperatures of 600° C. are shown in Table 2. The results of analysis on the amount of desorbed ammonia per weight of the removing agent obtained by the ammonia TPD-MS measurement are shown in Table 3.

### Example 5

A removing agent sample of Example 5 comprising χ alumina and a calcium oxide was prepared and stored in the same method and conditions of Example 1 except that a gibbsite powder (Al(OH)₃) and a calcium hydroxide powder were used as raw materials and the molar ratio Al(OH)₃:Ca(OH)₂ was 5:5. The tap density and the CF₄ removing agent capacity at the test temperatures of 600° C. are shown in Table 2. The results of analysis on the amount of desorbed ammonia per weight of the removing agent obtained by the ammonia TPD-MS measurement are shown in Table 3.

### Example 6

A removing agent sample of Example 6 of the molar ratio Al(OH)3:Ca(OH)2 of 3:7 was prepared and stored in the same method and conditions of Example 5. The tap density and the CF₄ removing agent capacity at the test temperatures of 600° C. are shown in Table 2. The results of analysis on the amount of desorbed ammonia per weight of the removing agent obtained by the ammonia TPD-MS measurement are shown in Table 3.

### Example 7

A removing agent sample of Example 7 of the molar ratio Al(OH)3:Ca(OH)2 of 2:8 was prepared and stored in the same method and conditions of Example 5. The tap density and the CF₄ removing agent capacity at the test temperatures of 600° C. are shown in Table 2. The results of analysis on the amount of desorbed ammonia per weight of the removing agent obtained by the ammonia TPD-MS measurement are shown in Table 3.

### Example 8

The tap density and the CF₄ removing agent capacity at the test temperatures of 500° C. of the sample prepared and stored in exactly the same method and conditions as in Example 3 are shown in Table 2.

### Example 9

The tap density and the CF₄ removing agent capacity at the test temperatures of 570° C. of the sample prepared and stored in exactly the same method and conditions as in Example 6 are shown in Table 2.

### Example 10

A removing agent sample comprising η alumina and a magnesium oxide was prepared and stored in the same method and conditions of Example 1 except that a bayerite powder and a magnesium hydroxide powder were used as raw materials and the molar ratio Al(OH)₃:Ca(OH)₂ was 3:7. The tap density and the CF₄ removing agent capacity at the test temperatures of 600° C. are shown in Table 2.

### Example 11

A removing agent sample of Example 11 comprising χ alumina and a magnesium oxide was prepared and stored in the same method and conditions of Example 1 except that a gibbsite powder and a magnesium hydroxide powder were used as raw materials and the molar ratio Al(OH)₃:Ca(OH)₂ was 3:7. The tap density and the CF₄ removing agent capacity at the test temperatures of 600° C. are shown in Table 2.

### Comparative Example 1

The removing agent sample of Comparative Example (Com. Ex.) 1 consisting only of a calcium oxide was prepared and stored in the same manner and conditions as in Example 1 except that only calcium hydroxide powder was used as a raw material. The tap density and the CF₄ removing agent capacity at the test temperatures of 600° C. are shown in Table 3.

### Comparative Example 2

The removing agent sample of Comparative Example 1 comprising γ alumina and a calcium oxide was prepared and stored in the same manner and conditions as in Example 1 except for using boehmite (AlOOH) powder and calcium hydroxide powder as raw materials and the molar ratio AlOOH:Ca(OH)₂ was 3:7. The tap density and the CF₄ removing agent capacity at the test temperatures of 600° C. are shown in Table 2. The results of analysis on the amount of desorbed ammonia per weight of the removing agent obtained by the ammonia TPD-MS measurement are shown in Table 3.

TABLE 2
CF₄ removing agent capacity of the fluorine-containing gas removing agent
comprising a crystalline alumina and an alkaline earth metal compound

| | | | Molar ratio | | | CF₄ |
|---|---|---|---|---|---|---|
| | | | Al atoms:Alkaline | | | removing |
| | Crystalline | Alkaline earth | earth | Tap | CF₄ gas | agent |
| | Alumina | metal compound | metal atoms | density | test temp. | capacity |
| Ex. 1 | η alumina | Calcium oxide | 5:5 | 0.76 g/ml | 600° C. | 99 L/kg |
| Ex. 2 | η alumina | Calcium oxide | 3:7 | 0.74 g/ml | 600° C. | 120 L/kg |
| Ex. 3 | η alumina | Calcium oxide | 2:8 | 0.74 g/ml | 600° C. | 129 L/kg |
| Ex. 4 | η alumina | Calcium oxide | 1:9 | 0.8 g/ml | 600° C. | 81 L/kg |
| Ex. 5 | χ alumina | Calcium oxide | 5:5 | 0.75 g/ml | 600° C. | 96 L/kg |
| Ex. 6 | χ alumina | Calcium oxide | 3:7 | 0.74 g/ml | 600° C. | 99 L/kg |
| Ex. 7 | χ alumina | Calcium oxide | 2:8 | 0.8 g/ml | 600° C. | 98 L/kg |
| Ex. 8 | η alumina | Calcium oxide | 2:8 | 0.74 g/ml | 500° C. | 84 L/kg |
| Ex. 9 | χ alumina | Calcium oxide | 3:7 | 0.74 g/ml | 570° C. | 82 L/kg |
| Ex. 10 | η alumina | Magnesium oxide | 3:7 | 0.71 g/ml | 600° C. | 137 L/kg |
| Ex. 11 | χ alumina | Magnesium oxide | 3:7 | 0.71 g/ml | 600° C. | 108 L/kg |
| Com. Ex. 1 | None | Calcium oxide | 0:10 | 0.79 g/ml | 600° C. | 0 L/kg |
| Com. Ex. 2 | γ alumina | Calcium oxide | 3:7 | 0.77 g/ml | 600° C. | 0 L/kg |

TABLE 3
Ratio of the desorbed ammonia amount (100 to 450° C.) <A> of
the fluorine-containing gas removing agents comprising a crystalline
alumina and an alkaline earth metal compound and as the value is 100,
the desorbed ammonia amount (230 to 450° C.) <B>.

| | Desorbed ammonia | Desorbed ammonia | <B> ratio |
|---|---|---|---|
| | (100 to 450° C.) | (230 to 450° C.) | when <A> is |
| | <A> | <B> | 100 |
| Ex. 1 | 73.0 mmol/kg | 33.0 mmol/kg | 46 |
| Ex. 2 | 47.6 mmol/kg | 22.7 mmol/kg | 48 |
| Ex. 3 | 34.9 mmol/kg | 15.4 mmol/kg | 44 |
| Ex. 4 | 21.7 mmol/kg | 7.9 mmol/kg | 44 |
| Ex. 5 | 25.5 mmol/kg | 10.2 mmol/kg | 40 |
| Ex. 6 | 14.9 mmol/kg | 6.4 mmol/kg | 43 |
| Ex. 7 | 10.7 mmol/kg | 4.4 mmol/kg | 41 |
| Com. Ex. 2 | 38.0 mmol/kg | 11.4 mmol/kg | 30 |

### Example 12

The tap density and the C₂F₆ removing agent capacity at the test temperatures of 600° C. of the sample prepared and stored in exactly the same method and conditions as in Example 3 are shown in Table 4.

### Example 13

The tap density and the C₂F₆ removing agent capacity at the test temperatures of 700° C. of the sample prepared and stored in exactly the same method and conditions as in Example 6 are shown in Table 4.

### Comparative Example 3

The tap density and the C₂F₆ removing agent capacity at the test temperatures of 600° C. of the sample prepared and stored in exactly the same method and conditions as in Comparative Example 2 are shown in Table 4.

TABLE 4
C₂F₆ removing agent capacity of the fluorine-containing gas removing
agents comprising a crystalline alumina and an alkaline earth metal compound.

| | | | Molar ratio Al | | | C₂F₆ |
|---|---|---|---|---|---|---|
| | | | atoms:Alkaline | | C₂F₆ | removing |
| | Crystalline | Alkaline earth | earth | Tap | gas test | agent |
| | Alumina | metal compound | metal atoms | density | temp. | capacity |
| Ex. 12 | η alumina | Calcium oxide | 2:8 | 0.74 g/ml | 600° C. | 78 L/kg |
| Ex. 13 | χ alumina | Calcium oxide | 3:7 | 0.74 g/ml | 700° C. | 56 L/kg |
| Com. Ex. 3 | γ alumina | Calcium oxide | 3:7 | 0.77 g/ml | 600° C. | 0 L/kg |

### Example 14

The effect of the reaction temperature on the CF₄ decomposition rate of the sample prepared and stored in exactly the same method and conditions as in Example 3 is shown in Table 5.

### Example 15

The effect of the reaction temperature on the CF₄ decomposition rate of the sample prepared and stored in exactly the same method and conditions as in Example 6 is shown in Table 5.

TABLE 5
Effect of reaction temperature to CF₄ decomposition rate of the fluorine-
containing gas removing agents comprising a crystalline alumina and an
alkaline earth metal compound.

| Example 14 | | Example 15 | |
|---|---|---|---|
| | CF₄ | | CF₄ |
| | decomposition | | decomposition |
| Temperature | rate | Temperature | rate |
| 299° C. | 0% | 301° C. | 0% |
| 329° C. | 7% | 331° C. | 0% |
| 359° C. | 25% | 361° C. | 1% |
| 389° C. | 64% | 392° C. | 5% |
| 420° C. | 99% | 422° C. | 13% |
| 450° C. or more | 100% | 453° C. | 30% |
| — | — | 480° C. | 60% |
| — | — | 510° C. | 93% |
| — | — | 543° C. or more | 100% |

### Analysis Example 1

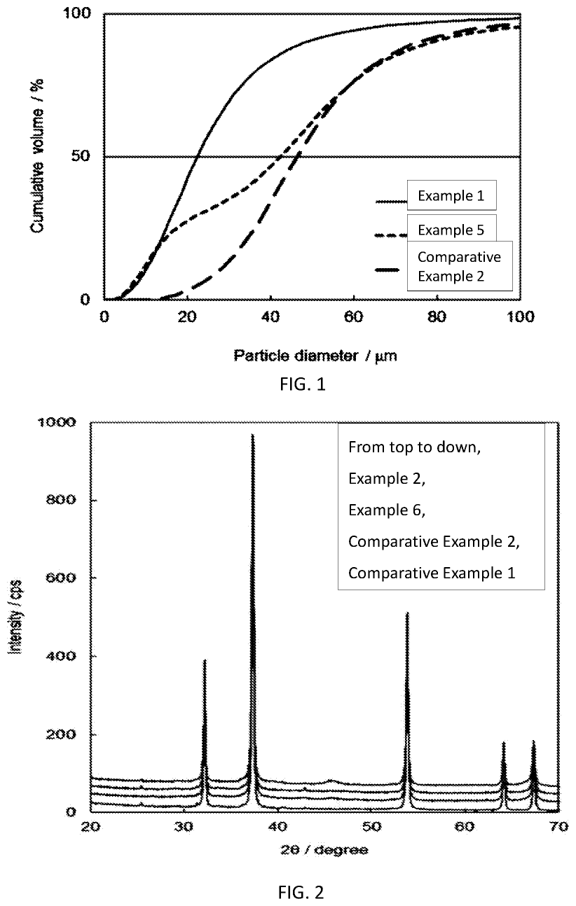

Particle size distribution measurements were carried out on the aluminum raw materials used for the preparation of the samples of Example 1 (aluminum raw material: bayalite), Example 5 (aluminum raw material: gibbsite), and Comparative Example 2 (aluminum raw material: boehmite), and the results are shown in FIG. 1.

Median diameter (Cumulative volume: Particle size at 50%) of the aluminum raw materials were bayerite: 22 μm, gibbsite: 4 2 μm and boehmite: 46 μm.

### Analysis Example 2

X-ray diffraction measurements were carried out on the samples of Example 2, Example 6, Comparative Example 1, and Comparative Example 2. These results are shown in FIG. 2. In drawing FIG. 2, the interval of each spectrum was shifted by 20 cps as the diffraction intensity in order to make each spectrum easier to compare.

FIG. 2 shows high intensity diffraction peaks (2θ=32.2°, 37.3°, 53.9°, 64.2°, 67.4°) derived from calcium oxide (PDF: 37-1497) for all samples. From this, it is understood that the calcium hydroxide used as a raw material was calcined and changed to calcium oxide. The calcination was carried out in an air atmosphere, but calcium carbonate was not confirmed. The PDF used as the basis for the identification of the diffractive patterns refers to the Powder Diffraction File (PDF) of the International Center for Diffraction Data (ICDD) (hereinafter, the same applies).

### Analysis Example 3

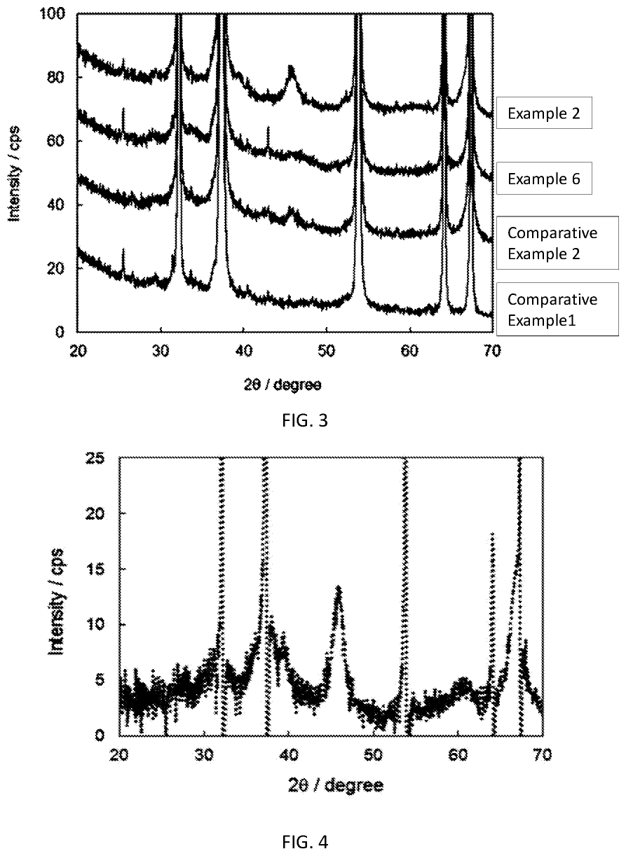

An enlarged view of focusing on the low-diffraction-intensity range (Intensity: 0-100 cps) in FIG. 2. is shown in FIG. 3. Aluminum hydroxide represented by Al(OH)₃ in the chemical formula includes bayerite, gibbsite, and nordstrandite. When they are fired at 700° C. under atmospheric pressure, it is possible to produce η alumina, χ alumina, and γ alumina via boehmite. As features of these activated alumina, it is known that they have a peak derived from ½ of the oxygen interatomic distance closely packed at a diffraction angle of 2θ=67°, and that the diffraction peak is broad at low intensity. Looking at the diffraction angle of 2θ=67° in FIG. 3, it can be seen that the other samples have a wider peak tail than the sample of the calcium oxide itself of Comparative Example 1. This shows that in Comparative Example 1 containing no aluminum raw material, only a high intensity and sharp peak of 2θ=67.4° caused by calcium oxide appears, whereas in the other samples, a low intensity and broad peak caused by activated alumina overlaps with a peak of 2θ=67.4° caused by calcium oxide. Activated alumina is known to have spots in electron diffraction images because it is crystalline. From these results and findings, it is concluded that the aluminum compounds contained in the samples of Example 2, Example 6, and Comparative Example 2 are all crystalline alumina.

### Analysis Example 4

Difference spectra between Example 2 (crystalline alumina+calcium oxide) and Comparative Example 1 (calcium oxide) were drawn and shown in FIG. 4 for the purpose of identifying the crystalline alumina comprised in Example 2.

In the difference spectrum of FIG. 4, the spectrum was disturbed at the diffraction angle of calcium oxide. Focusing on the part where the spectrum was not disturbed, diffraction peaks that could be obtained from either η alumina (PDF: 4-0875) or γ alumina (PDF: 10-0425) were confirmed. From the thermal transition sequence of aluminum hydroxide, it is reasonable to generate γ alumina from bayerite via η alumina or boehmite (if under hydrothermal conditions).

### Analysis Example 5

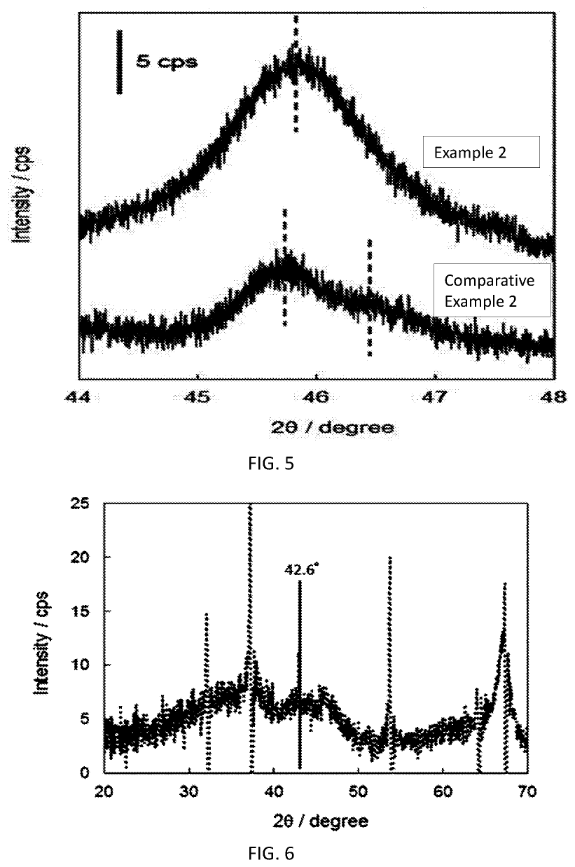

For the purpose of specifying the crystalline alumina (η alumina and/or γ alumina) comprised in Example 2, the diffraction patterns of Example 2 and Comparative Example 2 in the vicinity of 2θ=46° were compared in FIG. 5. Comparative Example 2 clearly contained γ-alumina from the thermal transition sequence of aluminum hydroxide.

It is known that the diffraction patterns of η alumina and γ alumina are very similar but there are differences in diffraction patterns around 2θ=46° and 2θ=67°. At both diffraction angle, η-alumina has one diffraction peak, whereas γ-alumina has two diffraction peaks, which may appear to be the main peak and shoulder. Referring to FIG. 5, it can be seen that Example 2 is η alumina having one diffraction peak, whereas Comparative Example 2 is γ alumina having two diffraction peaks.

### Analysis Example 6

For the purpose of specifying the crystalline alumina comprised in Example 6, the difference spectra of Example 6 (crystalline alumina+calcium oxide) and Comparative Example 1 (calcium oxide) were drawn and shown in FIG. 6. In the difference spectrum of FIG. 6, the spectrum is disturbed in the diffraction angle of calcium oxide. Focusing on the portion where the spectrum was not disturbed, a diffraction peak derived from χ alumina (PDF: 13-0373) was confirmed. As produced by firing gibbsite at atmospheric pressure, it is χ alumina, or γ-alumina via boehmite (if under hydrothermal conditions). It's known only χ alumina has a diffraction peak at 2θ=42.6°.

### Analysis Example 7

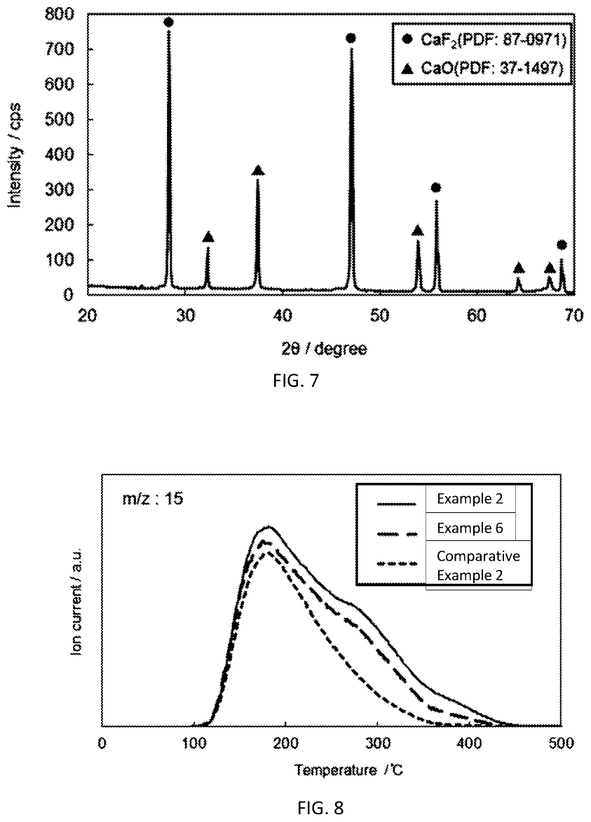

The evaluation test for the CF₄ removing capability at the test temperatures of 600° C. about the sample prepared in exactly the same method and conditions as in Example 2 for the purpose of examining the reaction product. When the CF₄ flow reached 15 hours, the flow was switched to N₂ air flow, and X-ray diffractometry was performed on samples cooled to room temperature. These results are shown in FIG. 7. In FIG. 7, high-intensity diffractive peaks derived from calcium oxide (37-1497) and calcium fluoride (PD F: 87-0971) were confirmed. Diffraction peaks derived from aluminum fluoride were not observed.

### Analysis Example 8

Ammonia desorption curves with mass-to-charge ratios of 15, which were investigated using the ammonia TPD-MS method, were compared for the removing agents of different types of crystalline aluminas. The result is shown in FIG. 8. The peak centrally 180° C. for all removing agent was confirmed. In addition, it was found that the removing agent comprising Example 2 (η alumina) and Example 6 (χ alumina), which had a high CF₄ removal capacity, had a common feature with a shoulder in the region of was 230-450° C. On the other hand, no shoulders or peaks were observed in the same regions in Comparative Example 2 (γ-alumina) in which the CF₄ removing capability was low. Based on these characteristics, it can be seen that the removing agent having a high CF₄ removing capability has an inflection point in the range of 260 to 280° C. in the ammonia desorption curve.

The results are summarized as follows.

(1) Alkaline earth metal oxides alone cannot decompose fluorine-containing gases (Comparative Example 1).
(2) The removing agent in which the alkaline earth metal oxide and the crystalline alumina η alumina or χ alumina are present in the form of a mixture exhibits a high fluorine-containing gas removal capacity (η alumina: Examples 1 to 4, Example 10, Example 12) (χ alumina: Examples 5 to 7, Example 11, Example 13). On the other hand, some removing agents even comprising a crystalline alumina have a low fluorine-containing gas removing ability, such as removing agents consisting of γ-alumina and alkaline earth metal oxides (γ-alumina: Comparative Example 2, Comparative Example 3).
(3) The removing agent containing η-alumina or χ-alumina having a high fluorine-containing gas-removing capability has a common characteristic in the ammonia TPD-MS spectrum. These removing agents have shoulders in the region of 230 to 450° C. in addition to peaks centered at 180° C. In view of these characteristics, a removing agent containing η alumina or χ alumina having a high fluorine-containing gas removing ability has an inflection point in a region of 260 to 280° C. On the other hand, since no shoulders or peaks are observed in the region of 230 to 450° C. in the removing agent containing γ-alumina having a low CF₄ removal capability, the removing agent does not have an inflection point in the region of 260 to 280° C. (Analysis Example 8).
(4) In the removing agent during the decomposition treatment of the fluorine-containing gas, the formation of aluminum fluoride is not observed while the alkaline earth metal oxide is changed to alkaline earth metal fluoride. Crystalline alumina does not change before and after the reaction, but serves as a catalyst to accelerate the reaction. Also, the maximal CF₄ decomposition throughput is determined by the content of alkaline-earth-metal compounds.
(5) From the above results, it is inferred that the fluorine-containing gas removal proceeds in parallel with the following three kinds of reactions.
(i) decomposition reaction of fluorine-containing gases on crystalline alumina catalyst surfaces with specific acid properties,
(ii) reaction where fluorine, the product of decomposition reaction, reacts with alkaline earth metal oxides to form alkaline earth metal fluorides, and
(iii) reaction where oxygen derived from alkaline earth metal oxide subjected to fluorination reaction combines with carbon of the product from reaction (i) to form CO₂.
(6) Both the removing agent containing η-alumina and the removing agent containing χ-alumina can decompose not only CF₄ but also C₂F₆, but a higher temperature is required to achieve the same level of fluorine-containing-gas removing capacity in the C₂F₆ process as during the CF₄ process (η alumina: Example 8, Example 12) (χ alumina: Example 9, Example 13).
(7) The η alumina-containing removing agent exhibits the same level of fluorine-containing gas removal capability at a lower reaction temperature than the χ alumina-containing removing agent (Example 8, Example 9). For example the reaction temperature required to remove 1000 ppmv of CF₄ was 450° C. or higher for the removing agent containing η alumina, whereas the reaction temperature required 543° C. or higher for the removing agent containing χ alumina (Examples 14 and 15).

From the above results, the removing agent comprising an alumina and an alkaline earth metal oxide and having the above characteristics of ammonia desorption curves by ammonia TPD-MS method could decompose and remove the fluorine-containing gas with high efficiency at a lower temperature compare to the conventional removing agent. In the decomposition treatment, there is no need to supply water vapor or oxygen gas from the outside, and in the removing agent the weight composition of the alkaline earth metal element which plays a fluorine immobilization function is large, and as a result, the treatment capacity as a removing agent is enhanced. It has been found that many specifications required as a fluorine-containing gas removing agent can be satisfied where high performance such as recover of fluorine by easily separating the calcium fluoride produced by immobilization, since the constituent metal of the removing agent comprises aluminum and alkaline earth metal elements and does not need to contain any third metal element.

1. A fluorine-containing gas removing agent comprising alumina and an alkaline earth metal compound, wherein an ammonia desorption curve by an ammonia TPD-MS method of mass-to-charge ratio 15 has a peak in a range of less than 200° C. and has a shoulder in a range of 200° C. or more.

2. The removing agent according to claim 1, wherein the shoulder is present in the range of 230 to 350° C.

3. The removing agent according to claim 1, wherein the amount of ammonia desorbed in a temperature range of 100 to 450° C. is 10.0 to 100.0 mmol/kg per weight of the removing agent in the ammonia TPD-MS spectrum measurement of the mass-to-charge ratio 15.

4. The removing agent according to claim 1, wherein the amount of ammonia desorbed in a temperature range of 230 to 450° C. is 35.0 to 55.0 when the amount of ammonia desorbed in a temperature range of 100 to 450° C. is 100 in the ammonia TPD-MS spectrum measurement of the mass-to-charge ratio 15.

5. The removing agent according to claim 1, wherein the alumina comprises a crystalline alumina.

6. The removing agent according to claim 5, wherein the crystalline alumina has a single peak in 2θ=45° to 47° in the X-ray diffraction pattern.

7. The removing agent according to claim 5, wherein the crystalline alumina comprises a η alumina.

8. The removing agent according to claim 5, wherein the crystalline alumina has a peak at 2θ=42.6°±0.5° in the X-ray diffraction pattern.

9. The removing agent according to claim 5, wherein the crystalline alumina comprises a χ alumina.

10. The removing agent according to claim 1, wherein the alkaline earth metal compound is at least one compound selected from the group consisting of a magnesium oxide, a calcium oxide, a magnesium carbonate, a calcium carbonate, a calcium hydroxide and a magnesium hydroxide.

11. The removing agent according to claim 1, wherein the molar ratio of aluminum atoms:alkaline earth metal atoms is 1:9 to 5:5.

12. The removing agent according to claim 1, wherein the sum of the weight of the aluminum oxide and the alkaline earth metal oxide is 70 weight % or more based on the total weight of the removing agent as aluminum atom is converted to an aluminum oxide (Al₂O₃) and the alkaline earth metal atom is converted to an alkaline earth metal oxide.

13. The removing agent according to claim 1, wherein the removing agent comprises no metal element other than aluminum and the alkaline earth metal.

14. The removing agent according to claim 1, wherein the fluorine-containing gas is selected from the group consisting of a fluorinated hydrocarbon and a perfluoro compound.

15. The removing agent according to claim 14, wherein the fluorinated hydrocarbon is selected from the group consisting of CHF₃, CH₂F₂, CH₃F, C₂HF₅, C₂H₂F₄, C₂H₃F₃, C₂H₄F₂ and C₂H₅F.

16. The removing agent according to claim 14, wherein the perfluoro compound is selected from the group consisting of CF₄, C₂F₆, C₃F₈, C₄F₁₀, C₄F₈, C₄F₆, C₅F₁₂, C₅F₁₀, C₅F₈, SF₆ and NF₃.

17. A method of manufacturing the removing agent according to claim 1, the method comprises steps of:
mixing and/or kneading η alumina and/or a χ alumina with an alkaline earth metal compound and optionally a dispersion medium;
forming the resulting mixture; and
optionally drying and/or calcining the formed mixture.

18. The method according to claim 17, wherein the drying is performed at 100 to 150° C.

19. The method according to claim 17, wherein the calcining is performed at 550 to 800° C.

20. A method of manufacturing the removing agent according to claim 1, the method comprises steps of:
mixing and/or kneading a bayalite and/or a gibbsite with an alkaline earth metal compound and optionally a dispersion medium;
forming the resulting mixture and optionally drying; and
calcining the formed mixture.

21. The method according to claim 20, wherein the drying is performed at 100 to 150° C.

22. The method according to claim 20, wherein the calcining is performed at 550 to 800° C.

23. A method of decomposing a fluorine-containing gas and immobilizing fluorine generated by the decomposition in a removing agent, the method comprises steps of:
heating the removing agent according to claim 1 to a temperature of 350 to 800° C.; and
inletting the fluorine-containing gas in the said removing agent at a space velocity of 100 to 1000 h⁻¹, while maintaining the above temperature.

24. The method according to claim 23, wherein the temperature is 350 to 600° C.

25. The method of decomposing and removing a fluorine-containing gas, the method comprises a step of:
contacting the fluorine-containing gas with the removing agent according to claim 1 without supplying water or oxygen from the outside.

26. A method of recovering fluorine from a fluorine-containing gas, the method comprises steps of:
decomposing the fluorine-containing gas by contacting the fluorine-containing gas and the removing agent according to claim 13, and immobilizing fluorine generated from the decomposition in the form of an alkaline earth metal fluoride in the removing agent;
optionally grinding the fluorine-immobilized removing agent to separate the alkaline earth metal fluoride and the alumina; and
separating fluorine from the removing agent by treating the fluorine-immobilized removing agent or the alkaline earth metal fluorides obtained from grinding/separating the removing agent with a solution to dissolve the alkaline earth metal fluoride.
